(19) United States
(12) Patent Application Publication
(10) Pub. No.: US 2014/0067553 A1
(43) Pub. Date: Mar. 6, 2014

(54) SYSTEM AND METHOD FOR PROVIDING OFFER ENGINEERING

(71) Applicants: Jeffery David Green, New Hyde Park, NY (US); J Robert Lieber, Surf City, NJ (US)

(72) Inventors: Jeffery David Green, New Hyde Park, NY (US); J Robert Lieber, Surf City, NJ (US)

(21) Appl. No.: 14/014,521

(22) Filed: Aug. 30, 2013

Related U.S. Application Data
(60) Provisional application No. 61/694,918, filed on Aug. 30, 2012.

(51) Int. Cl. G06Q 30/02

(52) U.S. Cl. CPC G06Q 30/0276
USPC 705/14.72

(57) ABSTRACT

The present invention generally relates to system and methods for providing improved marketing. Specifically, this invention relates to a system and method for evaluating and/or constructing and/or improving promotional offers for businesses of all sizes based on one or more criteria provided by the system, the user or any combination thereof.

### CROSS REFERENCE TO RELATED APPLICATIONS

This application claims the benefit of U.S. Provisional Patent Application No. 61/694,918, filed Aug. 30, 2012, the entire disclosure of which is incorporated herein by reference.

### FIELD OF THE INVENTION

The present invention generally relates to system and methods for providing improved marketing. Specifically, this invention relates to a system and method for evaluating and/or constructing and/or improving promotional offers for businesses of all sizes based on one or more criteria provided by the system, the user or any combination thereof.

### BACKGROUND

Businesses everywhere use promotional offers in order to advertise and sell their goods and services. Unsurprisingly, there are various systems that can assist a business in developing promotional offerings. However, currently available systems are incapable of breaking down a promotional offer into a variety and sequence of variables in order to score and evaluate the potential effectiveness or potential sales performance of that promotional offer and/or compare that promotional offer to other successful and unsuccessful promotional offers within and outside their own industry and provide advice for improvement.

Therefore, there is a need in the art for a system and method for designing and constructing a promotional offer by breaking the down the individual characteristics of the promotional offer and analyzing those details in order to maximize the effectiveness or performance of that promotional offer. These and other features and advantages of the present invention will be explained and will become obvious to one skilled in the art through the summary of the invention that follows.

### SUMMARY OF THE INVENTION

Accordingly, it is an object of the present invention to provide a system and method for evaluating and/or constructing and/or improving a promotional offer by breaking down the individual characteristics of the promotional offer and analyzing those details in order to maximize the effectiveness or performance of that promotional offer.

According to an embodiment of the present invention, a computer implemented system for providing offer engineering includes: an offer analysis and decision module, comprising computer-executable code stored in non-volatile memory, a variable module, comprising computer-executable code stored in non-volatile memory, a processor, and a communications means, wherein said offer analysis and decision module, said variable module, said processor, and said communications means are operably connected and are configured to: receive a selection of one or more priorities from a client, wherein said one or more priorities are related to a promotional offer; provide the client with objective setting prioritization guidelines; refine said selection of one or more priorities based on input from said client; provide options to the client regarding the selection of a target audience for the promotional offer; receive selection of the target audience from the client; dissect the promotional offer into a hierarchy of variables; analyze said hierarchy of variables; generate a score report based on said hierarchy of variables; generate offer decision advice, wherein said offer decision advice is based at least in part on said score report; and provide said offer decision advice to said client.

According to an embodiment of the present invention, the variables associated with the promotional offer are selected from the group comprising: market place dynamics, client category, client business, breadth of appeal, frequency of purchase, competitive offer activity, client brand, strength versus competition, offer mechanics, offer type, offer classification, offer vehicle, offer purchase channels, promotion overlays, offer value, offer denomination, offer value versus category average, price before offer, quality of value of top(lead) offer, offer timing, offer duration, offer start date, offer end date, offer expiration date, offer history, offer redemption difficulty, offer redemption terms, offer eligibility, offer complexity, offer purchase requirements, offer delivery media, media company, offer distribution media, offer medium, offer reach, offer circulation, estimated redemption date, size of the offer creative unit, other offer support, other offer support at retail, other offer support in paid media, other offer support in earned media, offer creative, offer linguistics, offer appeal, offer clarity, offer framing, offer urgency, length of subject line, match season, novelty in subject line, curiosity in subject line, quality of pre-header, clarity of value in offer, offer copy, copy passiveness, copy readability, copy understandability, copy intensity, copy sentiment, copy emotionality, offer execution, offer compellingness, offer impact, large visuals, lifestyle visual, in-situ visual, enjoyment visual, calls to action, offer costs, offer distribution, offer media costs, offer production cost, offer redemption, offer processing fee, cost per offer redeemed, media company fee, other offer support, other media cost, additional costs, offer return on investment (ROI), financial information, cost of goods sold, sales/offer redeemed, estimated ROI.

According to an embodiment of the present invention, the offer analysis and decision module, said variable module, said processor, and said communications means are further configured to generate an offer construction tool.

According to an embodiment of the present invention, the offer construction tool is configured to automatically update and provide analysis with respect to the promotional offer.

According to an embodiment of the present invention, the analysis provided by said offer construction tool is updated based at least in part on said variables.

According to an embodiment of the present invention, the analysis provided by said offer construction tool is updated based at least in part on information received from the client.

According to an embodiment of the present invention, a web-based system for providing offer engineering, includes: an offer analysis and decision module, comprising computer-executable code stored in non-volatile memory, a variable module, comprising computer-executable code stored in non-volatile memory, a processor, and a communications means, wherein said offer analysis and decision module, said variable module, said processor, and said communications means are operably connected and are configured to: receive a selection of one or more priorities from a client, wherein said one or more priorities are related to a promotional offer; provide the client with objective setting prioritization guidelines based on one or more variables associated with the promotional offer; refine said selection of one or more priorities based on input from said client; provide options to the client regarding the selection of a target audience for the promotional offer; receive selection of the target audience from the client; dissect the promotional offer into a hierarchy of variables; analyze said hierarchy of variables; generate a score report based on said hierarchy of variables; generate offer decision advice, wherein said offer decision advice is based at least in part on said score report; and provide said offer decision advice to said client.

According to an embodiment of the present invention, a computer-implemented (or web-based) method for providing offer engineering, the method comprising the steps of: receiving a selection of one or more priorities from a client, wherein said one or more priorities are related to a promotional offer; providing the client with objective setting prioritization guidelines based on one or more variables associated with the promotional offer; refining said selection of one or more priorities based on input from said client; providing options to the client regarding the selection of a target audience for the promotional offer; receiving selection of the target audience from the client; dissecting the promotional offer into a hierarchy of variables; analyzing said hierarchy of variables; generating a score report based on said hierarchy of variables; generating offer decision advice, wherein said offer decision advice is based at least in part on said score report; and providing said offer decision advice to said client.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3A illustrates a schematic overview of an exemplary offer engineering system, in accordance with an embodiment of the present invention;

FIG. 3B illustrates a schematic overview of an exemplary offer engineering system, in accordance with an embodiment of the present invention;

FIG. 4 illustrates a network schematic of a system, in accordance with an embodiment of the present invention;

FIG. 5 is a process flow for an exemplary offer engineering method, in accordance with an embodiment of the present invention;

FIG. 6 is a process flow for an exemplary offer engineering method, in accordance with an embodiment of the present invention;

FIGS. 7A-7F are a hierarchical view of analysis variables, in accordance with a preferred embodiment on the present invention; and

FIGS. 8A-8D are a tabular view of analysis variables, in accordance with a preferred embodiment on the present invention.

### DETAILED SPECIFICATION

The present invention generally relates to systems and methods for making investments via an electronic platform. Specifically, this invention relates to systems and methods for providing interactive investment trading via a computerized means whereby users are provided the ability to request and execute investment transactions while having these investment transactions first reviewed and audited by the system for appropriateness based on criteria previously set and specified by the system. In certain embodiments, investment transactions falling outside previously set parameters may be prevented or otherwise require the user to agree to a consequence for executing investment transactions outside the set parameters.

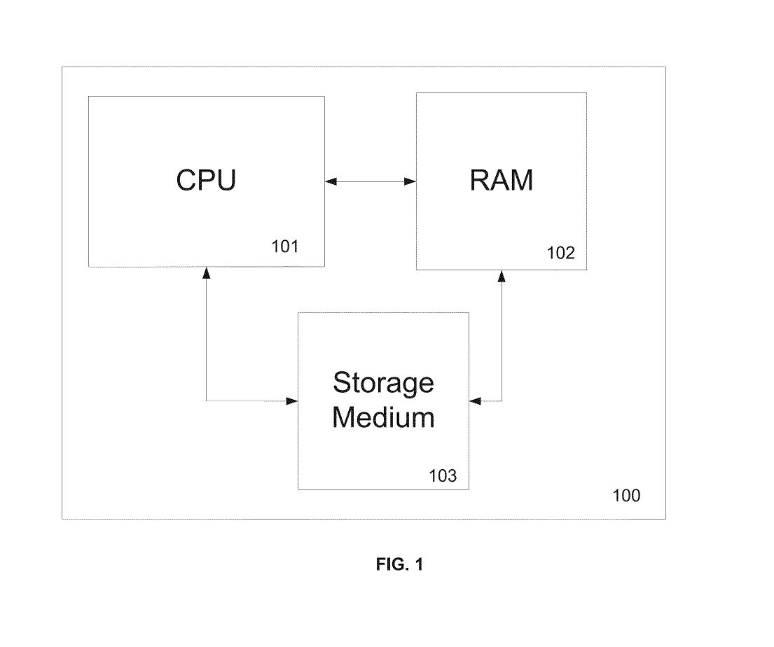

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks, wireless networks, near field communications) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention a user may be able to compose data offline that will be consumed by the system when the user is later connected to a network.

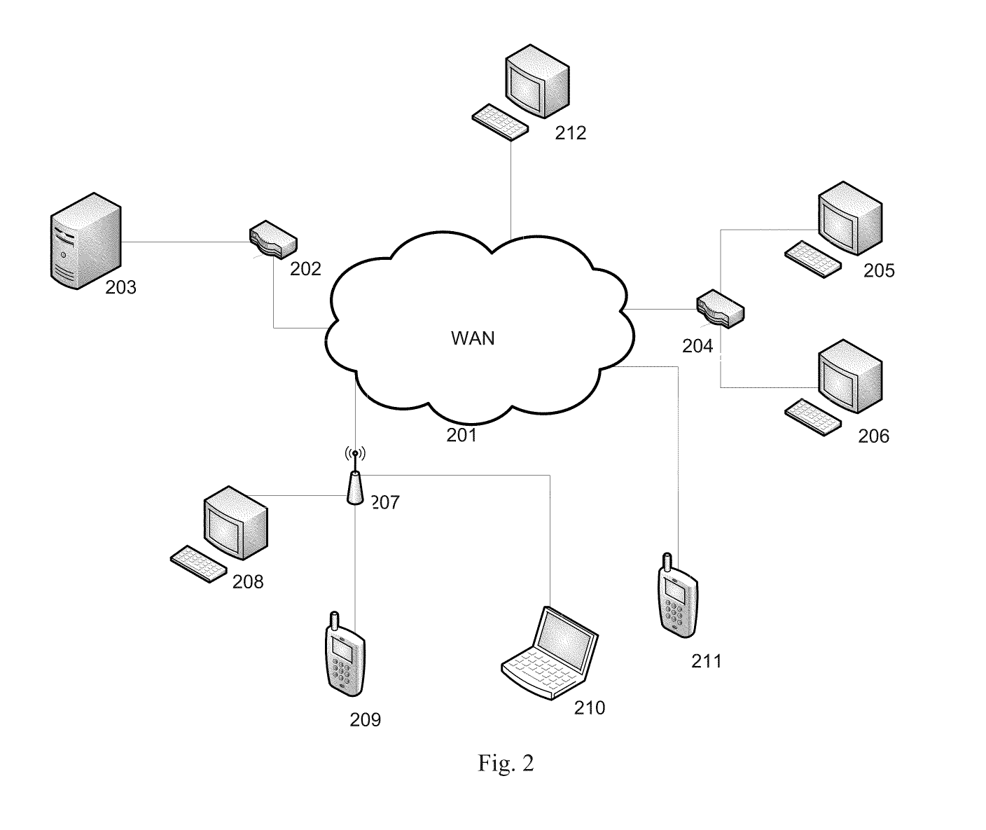

Referring to FIG. 2, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to. While many components of the system are web-based or otherwise utilize computing devices over networks, such as the internet, certain aspects of the invention may be provided by analog systems (e.g., landline telephones could be utilized to call and leave voicemails which may be digitized and converted into useable components within the system).

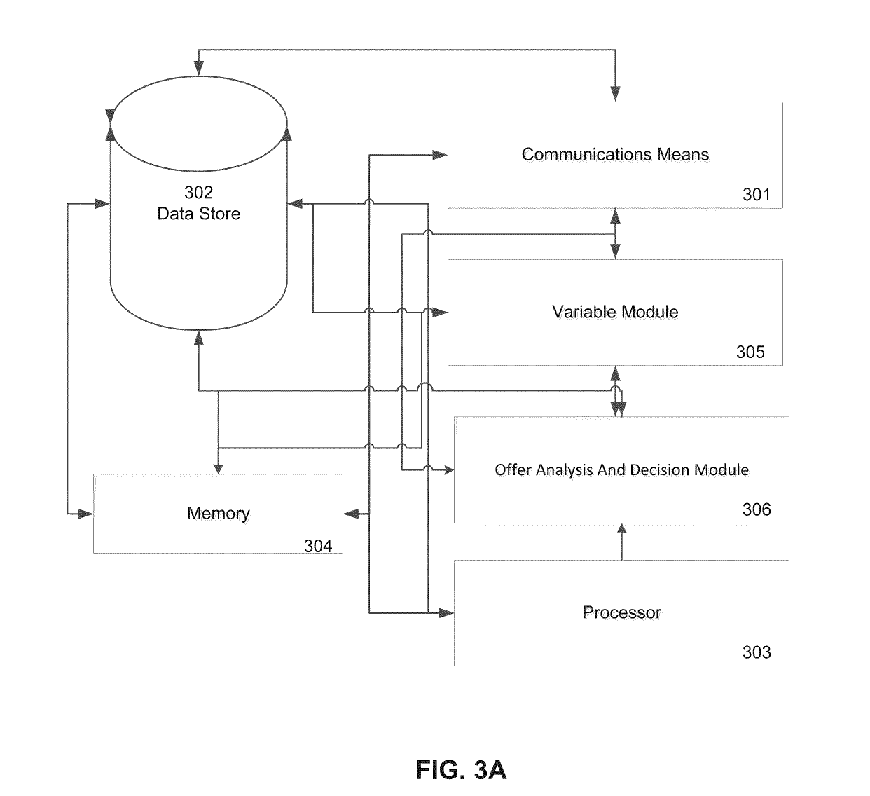

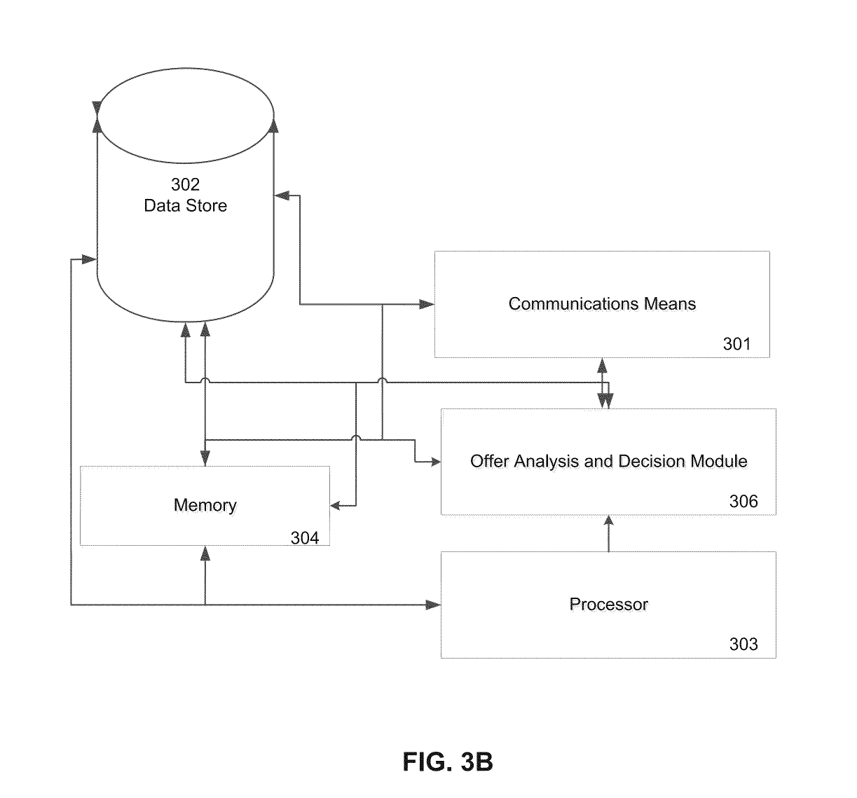

Turning to FIG. 3A, according to an embodiment of the present invention, a system for designing and constructing a promotional offer by breaking the down the individual characteristics of the promotional offer and analyzing those details in order to maximize the effectiveness or performance of that promotional offer is comprised of one or more communications means 301, one or more data stores 302, a processor 303, memory 404, a variable module 305 and an Offer Analysis and Decision (OAD) module 306. In alternate embodiments, the system may have additional or fewer components. For instance, as shown in FIG. 3B, the system may be comprised of one or more communications means 301, one or more data stores 302, a processor 303, memory 404 and an OAD module 306. In this embodiment, the OAD module 306 will have assumed the roles and processes provided by the variable module 305. One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data, voice or video communications over one or more networks. Appropriate communications means may include, but are not limited to, wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

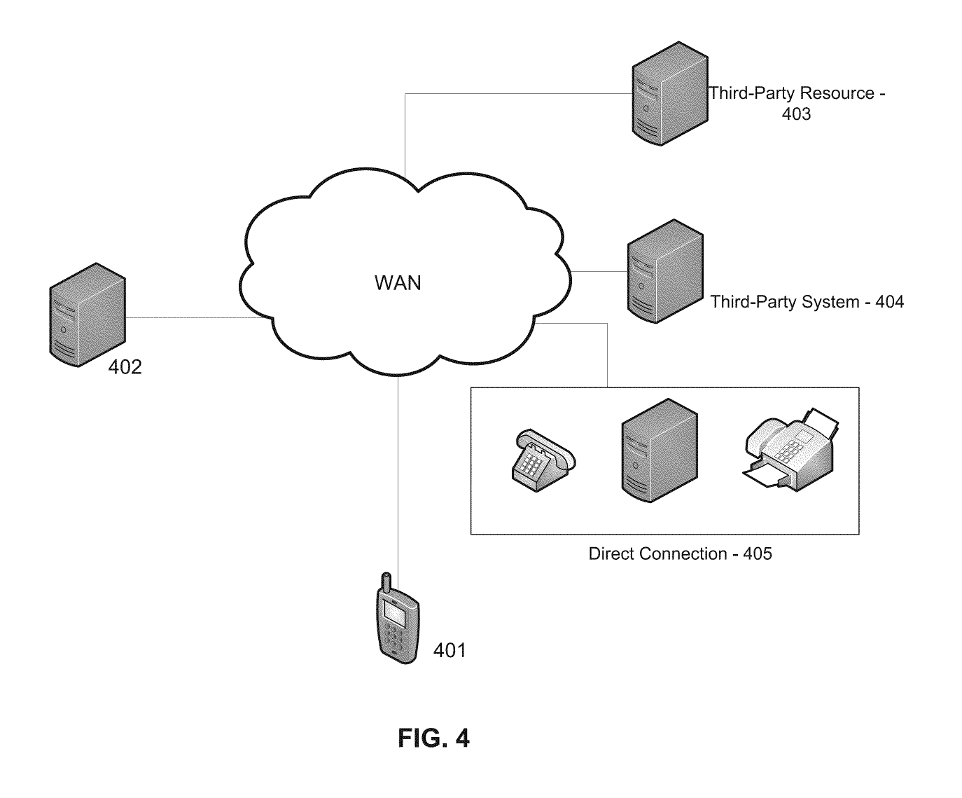

Turning now to FIG. 4, an expanded network schematic of a system in accordance with an embodiment of the present invention is shown. In FIG. 4, the system is shown as it may interact with users and other third party networks or Application Programming Interfaces (API). For instance, a user of a mobile device 401 may be able to connect to application server 402. Application server 402 may be able to enhance or otherwise provide additional services to the user by requesting, sending and receiving information from one or more of a third-party resource 403 (e.g., institutional research provider that provides independent research related to transactions via an API), a third party system 404 (e.g., third-party provider of analysis, performance or data related to variables such as click-through rates and impressions), one or more direct connections to service providers 405, or any combination thereof. For instance, in certain embodiments of the present invention, the system may utilize a connection to a third-party resource via an API in order to retrieve information related to a current offer/rebate issued by a client. One of ordinary skill in the art would appreciate how accessing one or more third-party systems could augment the ability of the system described herein, and embodiments of the present invention are contemplated for use with any third-party system.

According to an embodiment of the present invention, an offer engineering system is configured to engineer a promotional offer for a business. In general, the offer engineering system is configured to analyze, construct, improve and recommend one or more promotional offers based on criteria stored by the offer engineering system in conjunction with information provided by the user of the offer engineering system. The offer engineering system is configured to ensure that a particular promotional offer has a higher likelihood of meeting the goals of a business by analyzing a variety of variables and determining how each of those variables might affect the outcome of a particular promotional offer. In a preferred embodiment, the offer engineering system is comprised of an OAD process that helps increase the effectiveness of a promotional offer. In a preferred embodiment of the present invention, the OAD module is configured to utilize a series of steps (e.g., 6 steps) to achieve this purpose. In other embodiments, the OAD module may be configured to achieve the purpose with additional or fewer steps.

In embodiments where a variable module is utilized, the variable module may be configured to store, retrieve and provide characteristics of various variables utilized by the system. The variable module may allow for the insertion, update, deletion and fine tuning of variables utilized by the system. In other embodiments, the role of the variable module may be assumed and integrated into the OAD module. In other embodiments, the various processes and components of the system could be broken down into additional modules or fewer modules. The usage of additional modules may allow for greater distribution of the processing in large scale systems or requiring large scale processing needs. One of ordinary skill in the art would appreciate that components of the system could be distributed in any number of manners, including, but not limited to, cloud based execution, virtualized execution, local execution and distributed execution. Embodiments of the present invention are contemplated for use with any appropriate distribution of components.

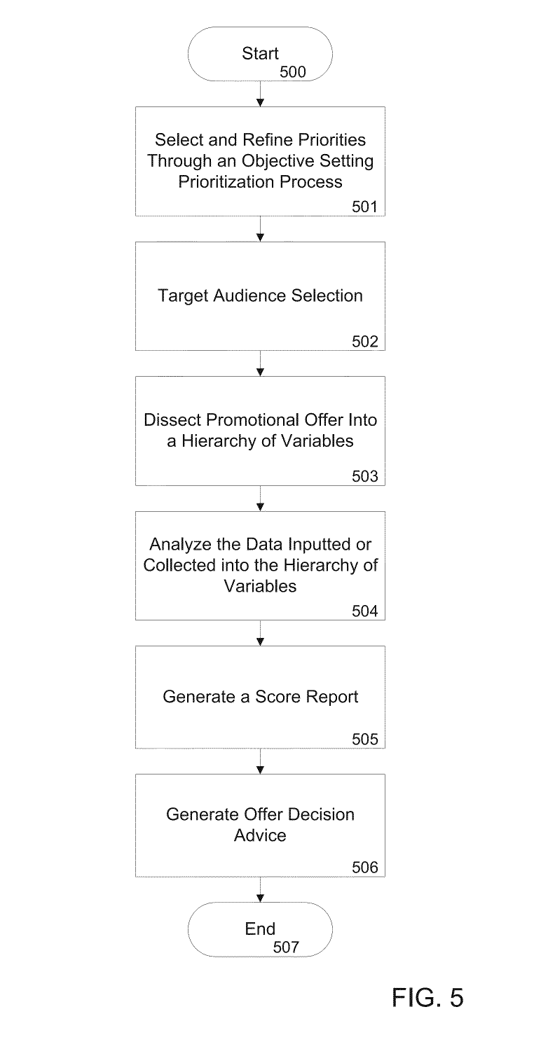

Turning now to FIG. 5, according to a preferred embodiment of the present invention, the first step 501 performed by the OAD module will be an Objective Setting Prioritization Process. In a preferred embodiment of this step, a client will be assisted in selecting and refining its primary goals with respect to a promotion offer. This may be achieved by presenting the client with one or more graphical user interfaces (GUIs), allowing the client to input information and/or select options presented to the client via the GUIs. The objective setting prioritization process utilizes a hierarchical structure of associated variables identified by the system in order to guide the client into refining their selection of priorities with respect to the goals of their promotional offer. The goal of the objective setting prioritization process is to have the client refine the purpose of their promotional offer to a narrowly tailored, achievable objective.

According to a preferred embodiment of the present invention, the second step 502 performed by the OAD module will be a Target Audience Selection. In a preferred embodiment of this step, a client will be assisted in selecting the appropriate target audience for a promotion offer. This may be achieved by presenting the client with one or more graphical user interfaces (GUIs), allowing the client to input information and/or select options presented to the client via the GUIs. In a preferred embodiment of the present invention, there will be an option for clients to customize the target audience selection based on their own segmentation scheme or other criteria.

According to a preferred embodiment of the present invention, the third step 503 performed by the OAD module is the dissection of a promotional offer. In a preferred embodiment of this step, the invention will help a client break down a promotional offer into multiple hierarchical layers or a selected combination of layers and/or individual variables. A client may choose to have any of its promotional offers studied, whether that promotional offer be a past, current, or planned promotional offer. In certain embodiments, the client can also input the details of a competitor's offer to determine how their own offers compare. Alternatively, the client can view the performance of other offers made in their industry to help them decide what to include or change in their offer. Such a capability allows a client to learn the weaknesses of past promotional offers, modify a current promotional offer to better achieve a specific set of objectives, and fully optimize future promotional offers. In an alternate embodiment of the present invention, the OAD module may be configured to automatically break down the promotional offer for the client.

According to an embodiment of the present invention, a promotional offer may be dissected into multiple hierarchical layers. In a preferred embodiment of the present invention, three hierarchical layers are utilized. In a preferred embodiment, the first layer would comprise one or more Categories of Offer Performance Variables, the second layer would comprise one or more Meta-Variables for Offer Performance, and the third layer would comprise one or more Detailed Offer Performance Variables. In any case, the OAD module would guide a client to provide input for each of the required variables or show them examples of competitive offers broken down by selected variables.

According to a preferred embodiment of the present invention, the Offer Performance Categories may include, but are not limited to, market place dynamics, offer mechanics, offer delivery media, offer creative, offer costs and offer return on investment. One of ordinary skill in the art would appreciate there are numerous variables that could be utilized as Offer Performance Categories and any number of variables may be used for the Offer Performance Categories, and embodiments of the present invention are contemplated with any such variables.

According to a preferred embodiment of the present invention, the Meta-Variables for Offer Performance may include client category, client brand, offer type, offer value, offer timing, offer redemption difficulty, offer distribution media, other offer support, offer linguistics, offer copy, offer execution, offer distribution costs, offer redemption costs, other offer support costs and financial information. One of ordinary skill in the art would appreciate any number of variables may be used for the Meta-Variables for Offer Performance, and embodiments of the present invention are contemplated with any such variables.

According to a preferred embodiment of the present invention, the Detailed Offer Performance Variables may include, but are not limited to, competitive offer activity, offer duration, offer purchase requirements, offer reach, offer appeal, offer clarity, offer media costs, and cost per offer redeemed. One of ordinary skill in the art would appreciate any number of variables may be used for the Detailed Offer Performance Variables (DOPV), and embodiments of the present invention are contemplated with any such variables.

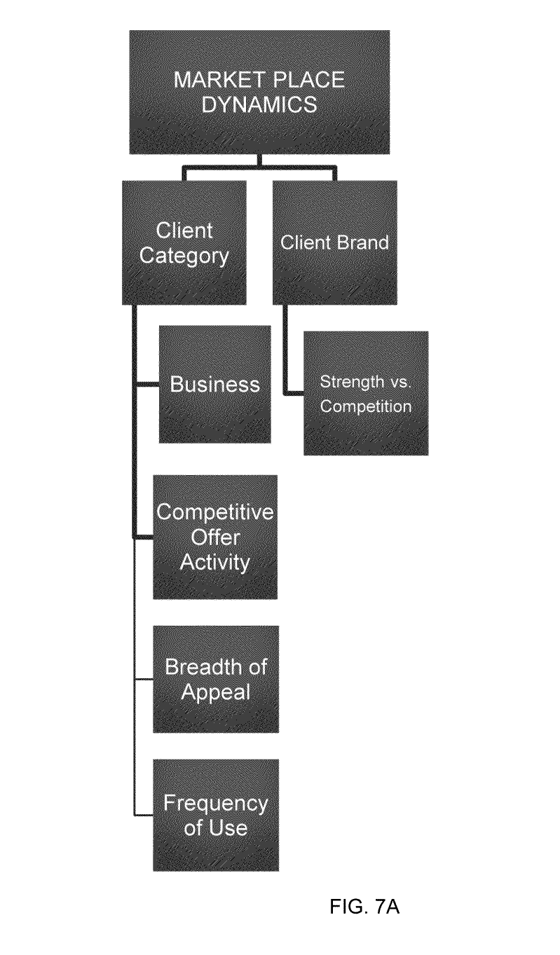

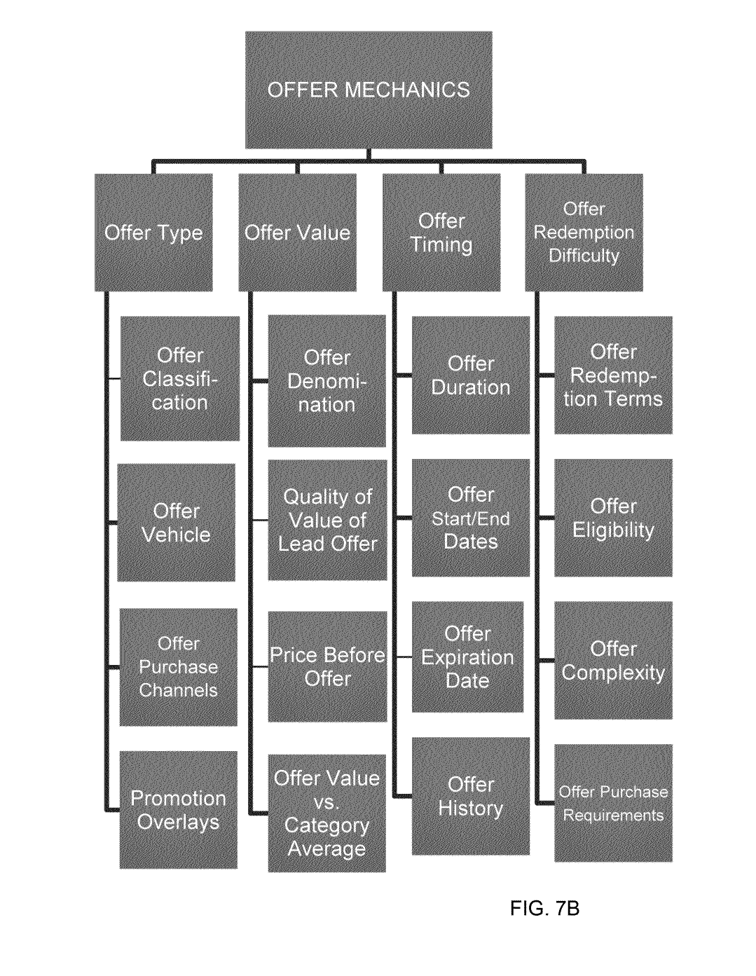

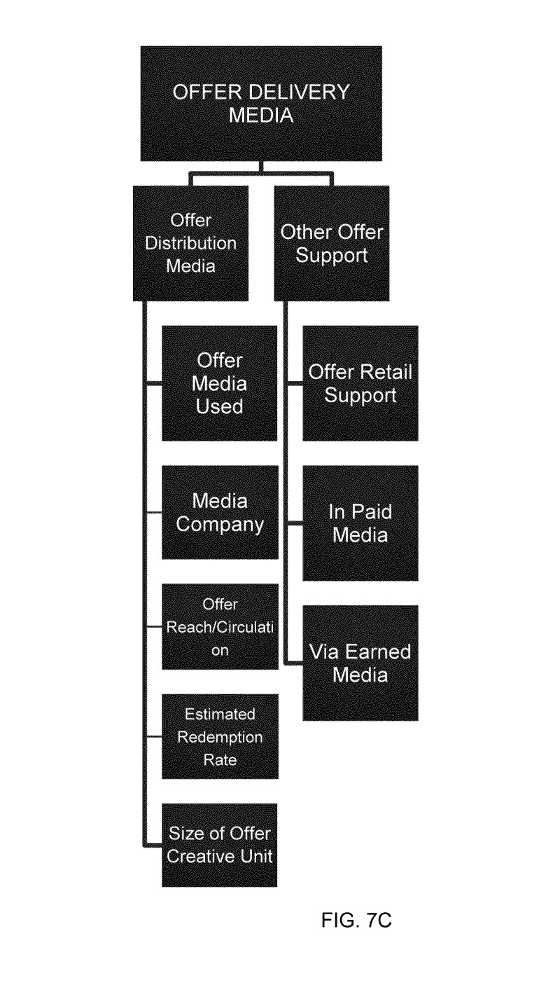

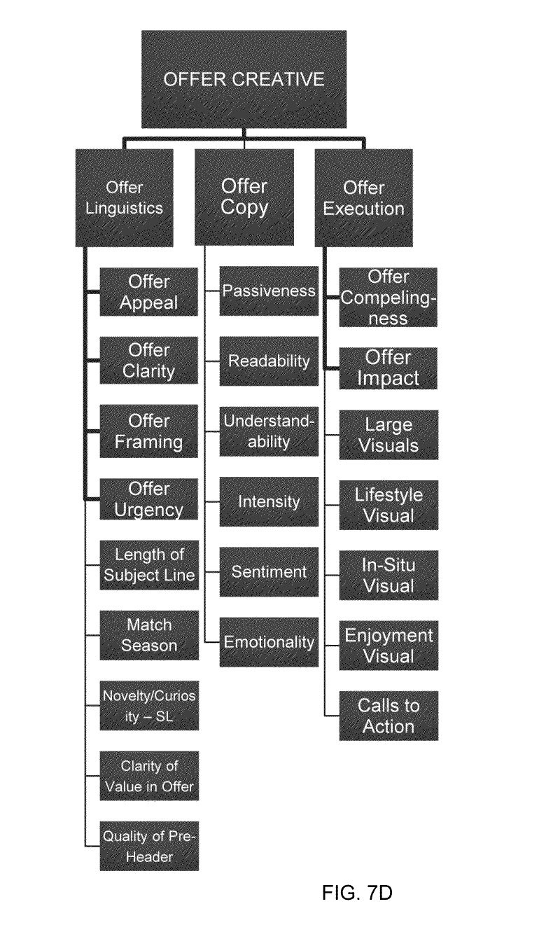

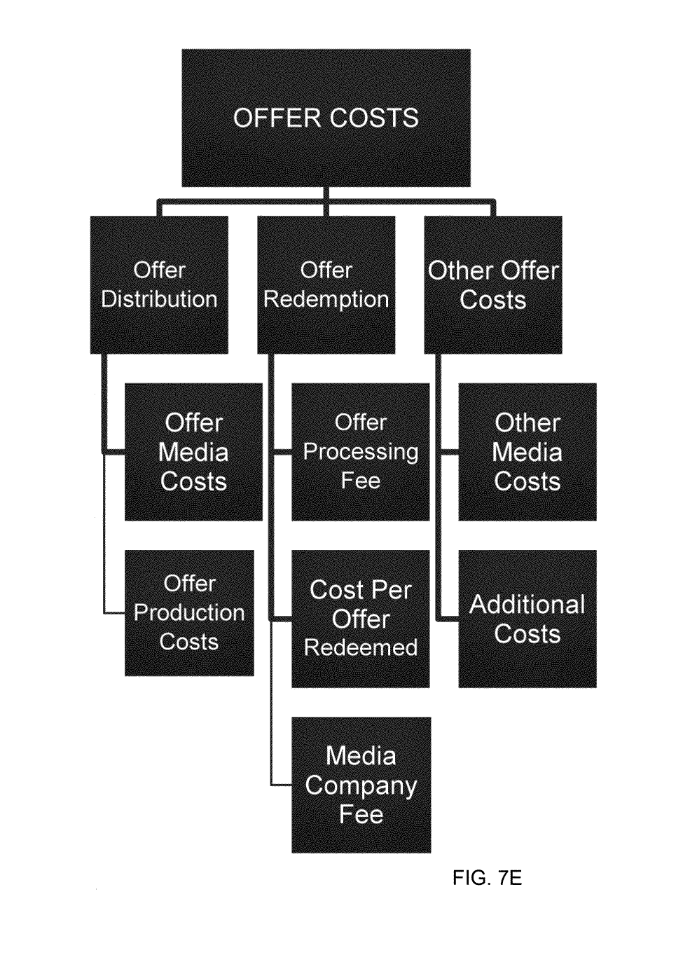

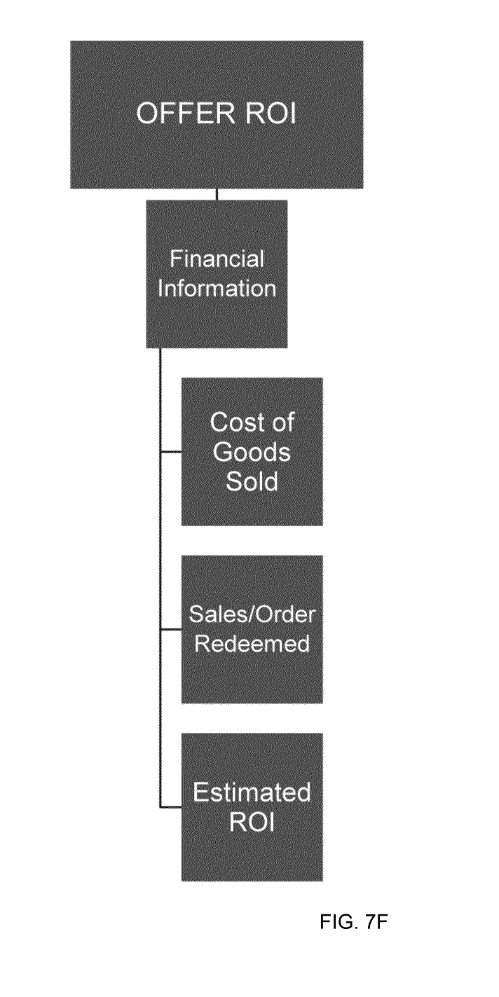

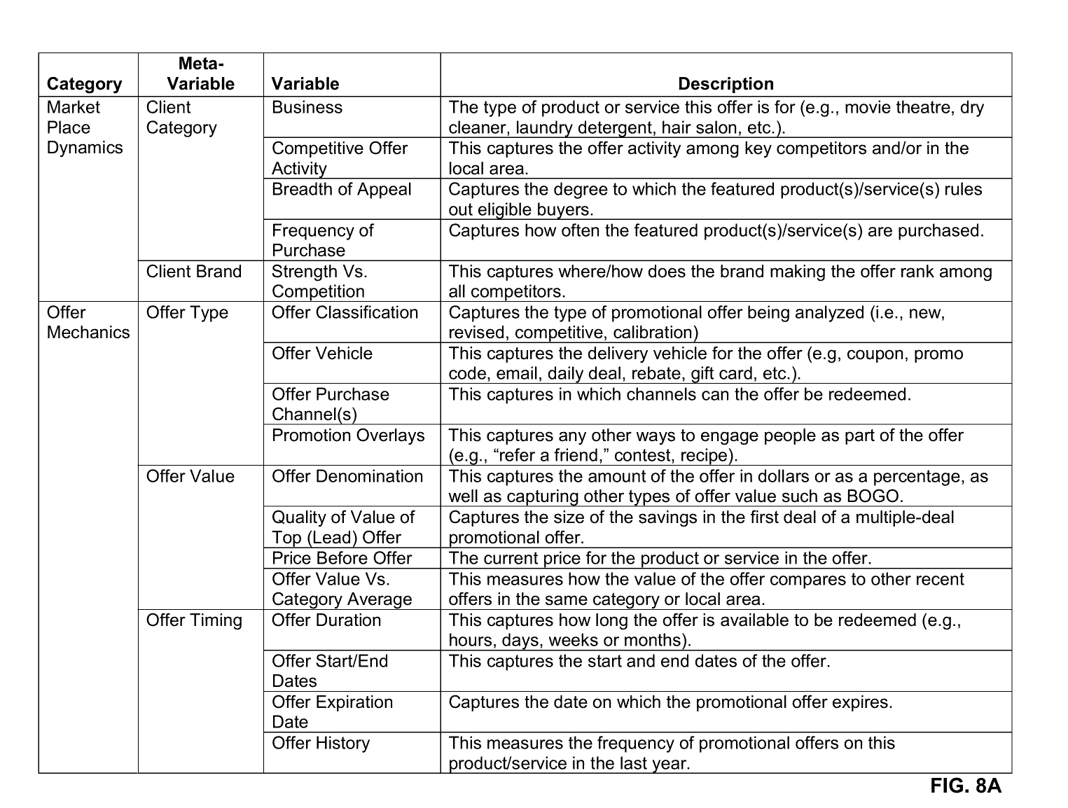

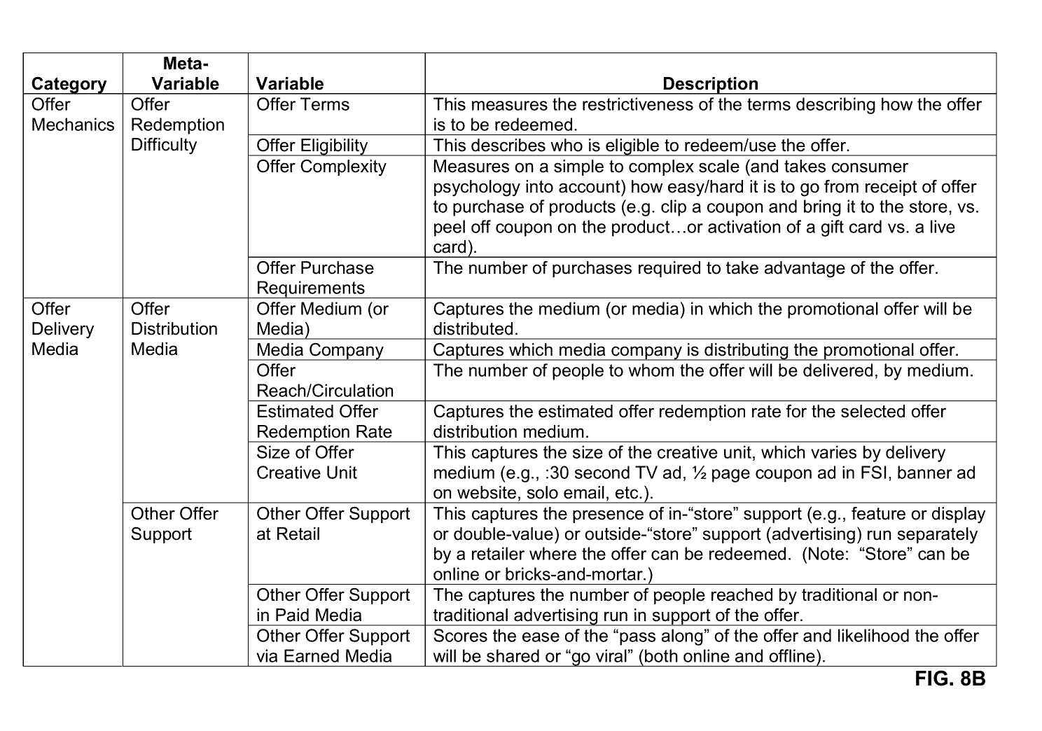

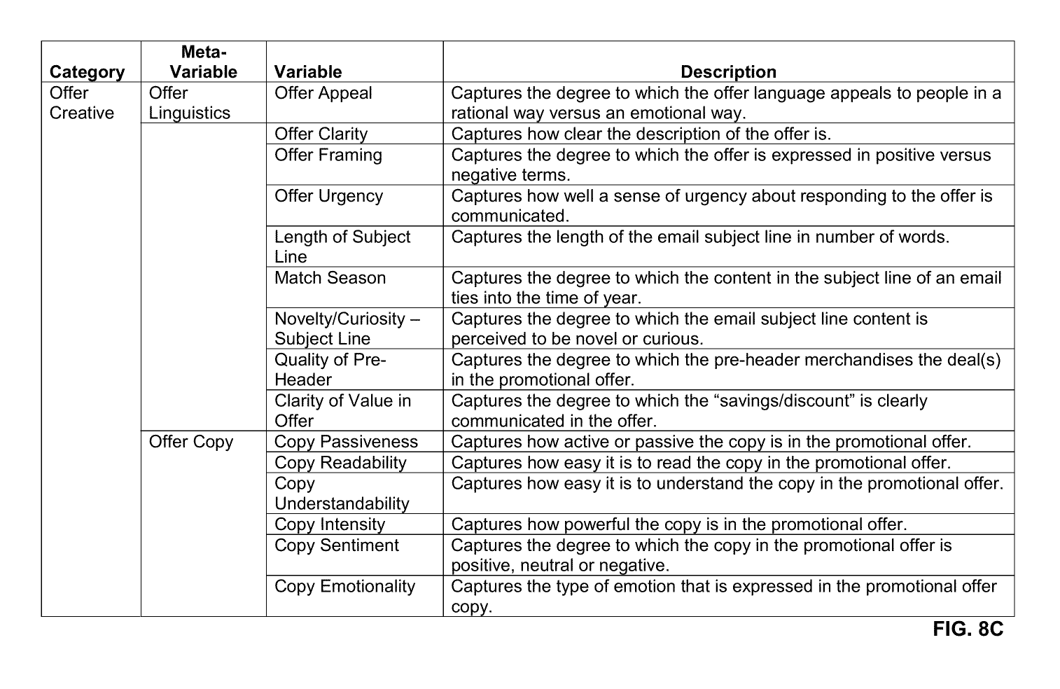

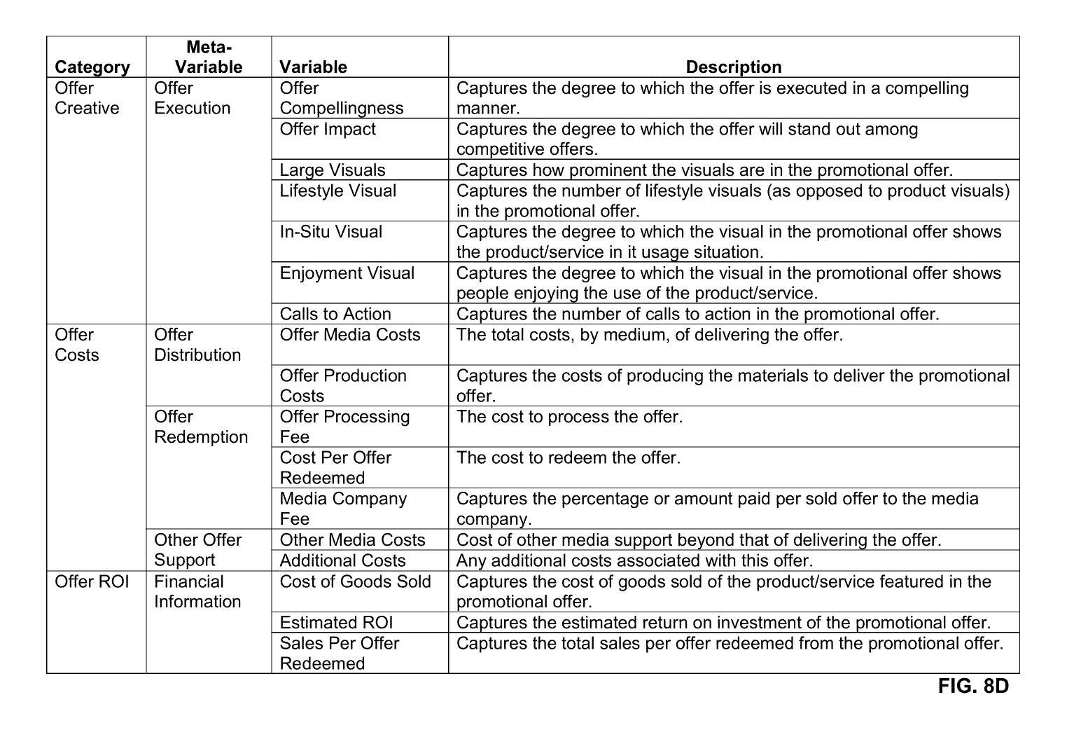

Referring to FIGS. 8A-8D, a table of analysis variables according to a preferred embodiment, is shown and referring to FIGS. 7A and 7F, the analysis variables are shown in a hierarchical view according to a preferred embodiment of the present invention.

According to a preferred embodiment of the present invention, the Business variable of the DOPVs is the type of product or service this offer is for (e.g., movie theatre, dry cleaner, laundry detergent, hair salon, etc.).

According to a preferred embodiment of the present invention, the Competitive Offer Activity variable of the DOPVs captures the offer activity among key competitors and/or in the local area.

According to a preferred embodiment of the present invention, the Strength vs. Completion variable of the DOPVs captures where/how does the brand making the offer rank among all competitors.

According to a preferred embodiment of the present invention, the Offer Vehicle variable of the DOPVs captures the delivery vehicle for the offer (e.g, coupon, promo code, email, daily deal, rebate, gift card, etc.).

According to a preferred embodiment of the present invention, the Offer Purchase Channel(s) variable of the DOPVs captures in which channels the offer can be redeemed (e.g. retail store, internet, telephone sales).

According to a preferred embodiment of the present invention, the Promotion Overlays variable of the DOPVs captures any other ways to engage people as part of the offer (e.g., “refer a friend,” contest, recipe).

According to a preferred embodiment of the present invention, the Offer Denomination variable of the DOPVs captures the amount of the offer in dollars or as a percentage, as well as capturing other types of offer value such as BOGO.

According to a preferred embodiment of the present invention, the Price Before Offer variable of the DOPVs is current price for the product or service in the offer before promotion.

According to a preferred embodiment of the present invention, the Offer Value vs. Category Average variable of the DOPVs measures how the value of the offer compares to other recent offers in the same category or local area.

According to a preferred embodiment of the present invention, the Offer Duration variable of the DOPVs captures how long the offer is available to be redeemed (e.g., hours, days, weeks or months).

According to a preferred embodiment of the present invention, the Offer Start/End Dates variable of the DOPVs captures the start and end dates of the offer.

According to a preferred embodiment of the present invention, the Offer History variable of the DOPVs measures the frequency of promotional offers on this product/service, by this client, in the last year.

According to a preferred embodiment of the present invention, the Offer Terms variable of the DOPVs measures the restrictiveness of the terms describing how the offer is to be redeemed.

According to a preferred embodiment of the present invention, the Offer Eligibility variable of the DOPVs describes who is or is not eligible to redeem/use the offer. (e.g. anyone under 18 years old).

According to a preferred embodiment of the present invention, the Offer Complexity variable of the DOPVs measures on a simple to complex scale (and takes consumer psychology into account) how easy/hard it is to go from receipt of offer to purchase of products (e.g. clip a coupon and bring it to the store, vs. peel off coupon on the product . . . or activation of a gift card vs. a live card).

According to a preferred embodiment of the present invention, the Offer Purchase Requirements variable of the DOPVs is the number of purchases required to take advantage of the offer or the required purchase of a certain dollar amount or companion products in order to be eligible to get the deal.

According to a preferred embodiment of the present invention, the Offer Reach/Circulation variable of the DOPVs is the number of people to whom the offer will be delivered, by medium.

According to a preferred embodiment of the present invention, the Size of Offer Creative Unit variable of the DOPVs captures the size of the creative unit, which varies by delivery medium (e.g., :30 second TV ad, ½ page coupon ad in FSI, size of banner ad on website, solo email, etc.).

According to a preferred embodiment of the present invention, the Other Offer Support at Retail variable of the DOPVs captures the presence of in-“store” support (e.g., feature or display or double-value) or outside-“store” support (advertising) run separately by a retailer where the offer can be redeemed. In a preferred embodiment, “store” can be online or bricks-and-mortar.

According to a preferred embodiment of the present invention, the Other Offer Support in Paid Media variable of the DOPVs captures the number of people reached by traditional or non-traditional advertising run in support of the offer.

According to a preferred embodiment of the present invention, the Other Offer Support via Earned Media variable of the DOPVs scores the ease of the “pass along” of the offer and likelihood the offer will be shared or “go viral” (both online and offline).

According to a preferred embodiment of the present invention, the Offer Appeal variable of the DOPVs captures the degree to which the offer language appeals to people in a rational way versus an emotional way.

According to a preferred embodiment of the present invention, the Offer Clarity variable of the DOPVs captures how clear the description of the offer is.

According to a preferred embodiment of the present invention, the Offer Framing variable of the DOPVs captures the degree to which the offer is expressed in positive versus negative terms.

According to a preferred embodiment of the present invention, the Offer Urgency variable of the DOPVs captures how well a sense of urgency about responding to the offer is communicated.

According to a preferred embodiment of the present invention, the Offer Compellingness variable of the DOPVs captures the degree to which the offer is executed in a compelling manner.

According to a preferred embodiment of the present invention, the Offer Impact variable of the DOPVs captures the degree to which the offer will stand out among competitive offers.

According to a preferred embodiment of the present invention, the Offer Media Costs variable of the DOPVs is the total costs, by medium, of delivering the offer.

According to a preferred embodiment of the present invention, the Offer Processing Fee variable of the DOPVs is the cost to process the offer, expressed as bank fee or service fee or clearinghouse fee or retailer handling fee.

According to a preferred embodiment of the present invention, the Cost Per Offer Redeemed variable of the DOPVs is the cost to redeem the offer to the client/business extending the offer.

According to a preferred embodiment of the present invention, the Other Media Costs variable of the DOPVs is the cost of other media support beyond that of delivering the offer.

According to a preferred embodiment of the present invention, the Additional Costs variable of the DOPVs is any additional costs associated with this offer.

According to a preferred embodiment of the present invention, Breadth of Appeal captures the degree to which the featured product(s)/service(s) rules out eligible buyers.

According to a preferred embodiment of the present invention, Frequency of Purchase captures how often the featured product(s)/service(s) are purchased.

According to a preferred embodiment of the present invention, Offer Classification captures the type of promotional offer being analyzed (i.e., new, revised, competitive, calibration).

According to a preferred embodiment of the present invention, Quality of Value of top (Lead) Offer captures the size of the savings in the first deal of a multiple-deal promotional offer.

According to a preferred embodiment of the present invention, Offer Expiration Date captures the date on which the promotional offer expires.

According to a preferred embodiment of the present invention, Offer Medium (or Media) captures the medium (or media) in which the promotional offer will be distributed.

According to a preferred embodiment of the present invention, Media Company captures which media company is distributing the promotional offer.

According to a preferred embodiment of the present invention, Estimated Offer Redemption Rate captures the estimated offer redemption rate for the selected offer distribution medium.

According to a preferred embodiment of the present invention, Length of Subject Line captures the length of the email subject line in number of words.

According to a preferred embodiment of the present invention, Match Season captures the degree to which the content in the subject line of an email ties into the time of year.

According to a preferred embodiment of the present invention, Novelty/Curiosity—Subject Line captures the degree to which the email subject line content is perceived to be novel or curious.

According to a preferred embodiment of the present invention, Quality of Pre-Header captures the degree to which the pre-header merchandises the deal(s) in the promotional offer.

According to a preferred embodiment of the present invention, Clarity of Value in Offer captures the degree to which the “savings/discount” is clearly communicated in the offer.

According to a preferred embodiment of the present invention, Copy Passiveness captures how active or passive the copy is in the promotional offer.

According to a preferred embodiment of the present invention, Copy Readability captures how easy it is to read the copy in the promotional offer.

According to a preferred embodiment of the present invention, Copy Understandability captures how easy it is to understand the copy in the promotional offer.

According to a preferred embodiment of the present invention, Copy Intensity captures how powerful the copy is in the promotional offer.

According to a preferred embodiment of the present invention, Copy Sentiment captures the degree to which the copy in the promotional offer is positive, neutral or negative.

According to a preferred embodiment of the present invention, Copy Emotionality captures the type of emotion that is expressed in the promotional offer copy.

According to a preferred embodiment of the present invention, Large Visuals captures how prominent the visuals are in the promotional offer.

According to a preferred embodiment of the present invention, Lifestyle Visual captures the number of lifestyle visuals (as opposed to product visuals) in the promotional offer.

According to a preferred embodiment of the present invention, In-Situ Visual captures the degree to which the visual in the promotional offer shows the product/service in it usage situation.

According to a preferred embodiment of the present invention, Enjoyment Visual captures the degree to which the visual in the promotional offer shows people enjoying the use of the product/service.

According to a preferred embodiment of the present invention, Calls to Action captures the number of calls to action in the promotional offer.

According to a preferred embodiment of the present invention, Offer Production Costs captures the costs of producing the materials to deliver the promotional offer.

According to a preferred embodiment of the present invention, Media Company Fee captures the percentage or amount paid per sold offer to the media company.

According to a preferred embodiment of the present invention, Cost of Goods Sold captures the cost of goods sold of the product/service featured in the promotional offer.

According to a preferred embodiment of the present invention, Estimated ROI captures the estimated return on investment of the promotional offer.

According to a preferred embodiment of the present invention, Sales Per Offer Redeemed captures the total sales per offer redeemed from the promotional offer.

According to a preferred embodiment of the present invention, the third step 503 performed by the Offer Analysis and Adjustment Machine will be analysis of the data input or collected into the OPVs, MVOPs, and DOPVs. In a preferred embodiment of this step, the invention will create scores for each of the variables. The score that is created through this analysis will weigh how much influence each variable has in achieving the desired objective of a given promotional offer.

According to a preferred embodiment of the present invention, the fourth step 504 performed by the Offer Analysis and Decision Module will be analysis of the data input or collected into any or all of the COPVs, MVOPs, and DOPVs. In a preferred embodiment of this step, the invention will use algorithms, other formulas, statistical analyses, calculations and scales to create scores for each of the variables input or collected. The scores that are created through this analysis will weigh both a) how much influence each variable has in achieving the desired objective(s) or results of a given promotional offer and b) the strength of that offer with respect to each variable. Alternative embodiments of the present invention may utilize different variables calculated at various weights for scoring the strength of an offer. One of ordinary skill in the art would appreciate that there are numerous variables and weights that could be utilized by embodiments of the present invention, and embodiments of the present invention are contemplated for use with any variables and weighting of those variables for use in calculating the strength of an offer.

According to a preferred embodiment of the present invention, the fourth step 504 may optionally include the sub-step of comparing the generated scores to the scores of past promotional offers or offers of competitors. In a preferred embodiment, the scores of a client's given promotional offer may be compared to the scores of previous promotional offers, both successful and unsuccessful, that are in a similar business category as the client. Additional embodiments may include a “Hall of Fame of Offers” or “Top Monthly Offers” or “Top Competitors' Offers” where a client's given promotional offer may be compared to the most successful promotional offers across all business categories as well as comparisons to successful and unsuccessful promotional offers in different and/or related business categories.

According to a preferred embodiment of the present invention, the fifth step 505 performed by the Offer Analysis and Decision Module will be the generation of reports and indices. These reports and indices are intended to help a client evaluate the inputted or collected data about all or selected DOPVs and provide further comparison to the benchmarks used in the fourth step 504. In a preferred embodiment of the fifth step 505 the reports and indices may include, but are not limited to charts, graphs, tables, and other graphical and textual representations of analyses performed on the inputted data. One of ordinary skill in the art would appreciate a variety of reports and indices might be generated, and embodiments of the present invention are contemplated to use any such report or index.

According to a preferred embodiment of the present invention, the sixth step 506 performed by the Offer Analysis and Decision Machine is Offer Decision Advice. In a preferred embodiment of this step, advice about DOPV-based decisions is generated based on the analysis of the data input or collected into the variables and the scores those variables received in the fourth step 504. The advice provides the client with information on how and where to improve a promotional offer by citing weaknesses in a given variable. In a preferred embodiment, the advice may include specific examples of how other businesses have improved the specifically targeted variables. The process then terminates at Step 507.

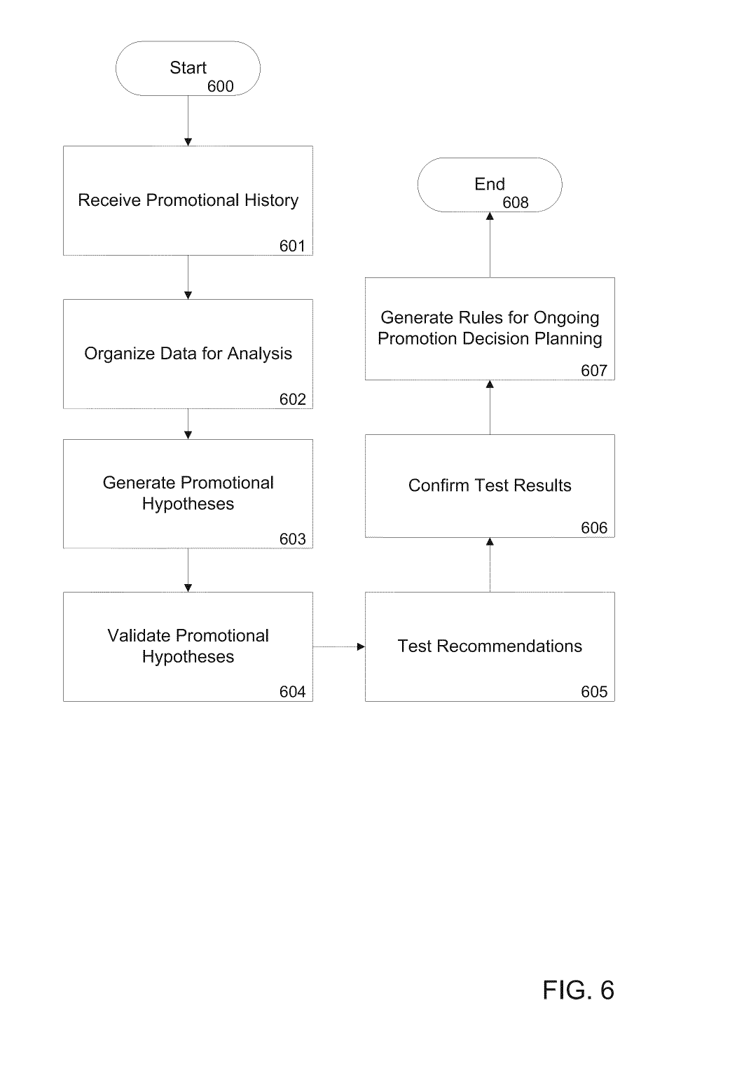

Turning now to FIG. 6, another exemplary method is shown. According to this exemplary method, the first step 601 is performed by the OAD module through receipt of promotional history data from a client. The client provides the promotional history to the system in order to gain meaningful business improvements from the performance of their promotional offers.

At step 602, the system organizes the client's data for analysis based on media in which the offers were distributed and the results data provided (e.g., by subject line, click behavior and transaction behavior for offers distributed in email).

At step 603, the system generates hypotheses as to which variables would generate the most improvement in offer performance for the client. This is done based on a “Knowledgebase of Learning” retained in the OAD module. The knowledgebase of learning is a compendium of research studies and actual tests on Offer Performance and the system's analyses of offers the system (e.g., the OAD module) has studied in the industry of the client and across all industries.

At step 604, the system runs statistical analyses to prove or disprove the hypotheses of the OAD module. In this stage the system also prioritizes which variables explain the most variance in offer performance.

At step 605, the system recommends which variables should be tested and advises the client on the best way to structure in-market tests that will help the client achieve improved offer performance.

At step 606, the system has received results from the client and analyzes the results. At this point, the system confirms that improved results can be consistently achieved.

At step 607 once test results have been confirmed, the changes that the system prescribed to the client are converted into business rules and best practices for that client to implement on an ongoing basis. (e.g., for DOPV “Quality of Value of Top (Lead) Offer the business rule is as follows: savings less than 15%=negative influence on performance; savings is 15%-35%=neutral influence on performance; savings greater than 35%=positive influence on performance. The best practice is to feature large savings in top(lead) offers to maximize click rates.) The end result is an “Offer Construction Tool” that helps the client make ongoing decisions when planning promotional offers. This offer construction tool can be continually updated as results are received and analyzed so that it can remain effective over time. The process then terminates at step 608.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer implemented system for providing offer engineering, the system comprising:
an offer analysis and decision module, comprising computer-executable code stored in non-volatile memory,
a variable module, comprising computer-executable code stored in non-volatile memory,
a processor, and
a communications means,
wherein said offer analysis and decision module, said variable module, said processor, and said communications means are operably connected and are configured to:
receive a selection of one or more priorities from a client, wherein said one or more priorities are related to a promotional offer;
provide the client with objective setting prioritization guidelines based on one or more variables associated with the promotional offer;
refine said selection of one or more priorities based on input from said client;
provide options to the client regarding the selection of a target audience for the promotional offer;
receive selection of the target audience from the client;
dissect the promotional offer into a hierarchy of variables;
analyze said hierarchy of variables;
generate a score report based on said hierarchy of variables;
generate offer decision advice, wherein said offer decision advice is based at least in part on said score report; and
provide said offer decision advice to said client.

2. The system of claim 1, wherein the variables associated with the promotional offer are selected from the group comprising: market place dynamics, client category, client business, breadth of appeal, frequency of purchase, competitive offer activity, client brand, strength versus competition, offer mechanics, offer type, offer classification, offer vehicle, offer purchase channels, promotion overlays, offer value, offer denomination, offer value versus category advantage, price before offer, offer value vs. category average, offer timing, offer duration, offer start date, offer end date, offer expiration date, offer history, offer redemption difficulty, offer redemption terms, offer eligibility, offer complexity, offer purchase requirements, offer delivery media, media company, offer distribution media, offer reach, offer circulation, estimated redemption date, size of the offer creative unit, other offer support, offer creative, offer linguistics, offer appeal, offer clarity, offer framing, offer urgency, length of subject line, match season, novelty subject line, curiosity subject line, quality of pre-header, clarity of value in offer, offer copy, copy passiveness, copy readability, copy understandability, copy intensity, copy sentiment, copy emotionality, offer execution, offer compellingness, offer impact, large visuals, lifestyle visual, in-situ visual, enjoyment visual, calls to action, offer costs, offer distribution, offer media costs, offer production cost, offer redemption, offer processing fee, cost per offer redeemed, media company fee, offer support, other media cost, additional costs, offer return on investment (ROI), financial information, cost of goods sold, sales/order redeemed, estimated ROI.

3. The system of claim 1, wherein said offer analysis and decision module, said variable module, said processor, and said communications means are further configured to generate an offer construction tool.

4. The system of claim 3, wherein said offer construction tool is configured to automatically update and provide analysis with respect to the promotional offer.

5. The system of claim 4, wherein the analysis provided by said offer section tool is updated based at least in part on said variables.

6. The system of claim 4, wherein the analysis provided by said offer section tool is updated based at least in part on information received from the client.

7. A web-based system for providing offer engineering, the system comprising:
an offer analysis and decision module, comprising computer-executable code stored in non-volatile memory,
a variable module, comprising computer-executable code stored in non-volatile memory,
a processor, and
a communications means,
wherein said offer analysis and decision module, said variable module, said processor, and said communications means are operably connected and are configured to:
receive a selection of one or more priorities from a client, wherein said one or more priorities are related to a promotional offer;
provide the client with objective setting prioritization guidelines based on one or more variables associated with the promotional offer;
refine said selection of one or more priorities based on input from said client;
provide options to the client regarding the selection of a target audience for the promotional offer;
receive selection of the target audience from the client;
dissect the promotional offer into a hierarchy of variables;
analyze said hierarchy of variables;
generate a score report based on said hierarchy of variables;
generate offer decision advice, wherein said offer decision advice is based at least in part on said score report; and
provide said offer decision advice to said client.

8. The system of claim 7, wherein the variables associated with the promotional offer are selected from the group comprising: market place dynamics, client category, client business, breadth of appeal, frequency of purchase, competitive offer activity, client brand, strength versus competition, offer mechanics, offer type, offer classification, offer vehicle, offer purchase channels, promotion overlays, offer value, offer denomination, offer value versus category advantage, price before offer, offer value vs. category average, offer timing, offer duration, offer start date, offer end date, offer expiration date, offer history, offer redemption difficulty, offer redemption terms, offer eligibility, offer complexity, offer purchase requirements, offer delivery media, media company, offer distribution media, offer reach, offer circulation, estimated redemption date, size of the offer creative unit, other offer support, offer creative, offer linguistics, offer appeal, offer clarity, offer framing, offer urgency, length of subject line, match season, novelty subject line, curiosity subject line, quality of pre-header, clarity of value in offer, offer copy, copy passiveness, copy readability, copy understandability, copy intensity, copy sentiment, copy emotionality, offer execution, offer compellingness, offer impact, large visuals, lifestyle visual, in-situ visual, enjoyment visual, calls to action, offer costs, offer distribution, offer media costs, offer production cost, offer redemption, offer processing fee, cost per offer redeemed, media company fee, offer support, other media cost, additional costs, offer return on investment (ROI), financial information, cost of goods sold, sales/order redeemed, estimated ROI.

9. The system of claim 7, wherein said offer analysis and decision module, said variable module, said processor, and said communications means are further configured to generate an offer construction tool.

10. The system of claim 9, wherein said offer construction tool is configured to automatically update and provide analysis with respect to the promotional offer.

11. The system of claim 10, wherein the analysis provided by said offer section tool is updated based at least in part on said variables.

12. The system of claim 10, wherein the analysis provided by said offer section tool is updated based at least in part on information received from the client.

13. A computer implemented method for providing offer engineering, the method comprising the steps of:
receiving a selection of one or more priorities from a client, wherein said one or more priorities are related to a promotional offer;
providing the client with objective setting prioritization guidelines based on one or more variables associated with the promotional offer;
refining said selection of one or more priorities based on input from said client;
providing options to the client regarding the selection of a target audience for the promotional offer;
receiving selection of the target audience from the client;
dissecting the promotional offer into a hierarchy of variables;
analyzing said hierarchy of variables;
generating a score report based on said hierarchy of variables;
generating offer decision advice, wherein said offer decision advice is based at least in part on said score report; and
providing said offer decision advice to said client.

14. The method of claim 13, wherein the variables associated with the promotional offer are selected from the group comprising: market place dynamics, client category, client business, breadth of appeal, frequency of purchase, competitive offer activity, client brand, strength versus competition, offer mechanics, offer type, offer classification, offer vehicle, offer purchase channels, promotion overlays, offer value, offer denomination, offer value versus category advantage, price before offer, offer value vs. category average, offer timing, offer duration, offer start date, offer end date, offer expiration date, offer history, offer redemption difficulty, offer redemption terms, offer eligibility, offer complexity, offer purchase requirements, offer delivery media, media company, offer distribution media, offer reach, offer circulation, estimated redemption date, size of the offer creative unit, other offer support, offer creative, offer linguistics, offer appeal, offer clarity, offer framing, offer urgency, length of subject line, match season, novelty subject line, curiosity subject line, quality of pre-header, clarity of value in offer, offer copy, copy passiveness, copy readability, copy understandability, copy intensity, copy sentiment, copy emotionality, offer execution, offer compellingness, offer impact, large visuals, lifestyle visual, in-situ visual, enjoyment visual, calls to action, offer costs, offer distribution, offer media costs, offer production cost, offer redemption, offer processing fee, cost per offer redeemed, media company fee, offer support, other media cost, additional costs, offer return on investment (ROI), financial information, cost of goods sold, sales/order redeemed, estimated ROI.

15. The method of claim 13, wherein said offer analysis and decision module, said variable module, said processor, and said communications means are further configured to generate an offer construction tool.

16. The method of claim 15, wherein said offer construction tool is configured to automatically update and provide analysis with respect to the promotional offer.

17. The method of claim 16, wherein the analysis provided by said offer section tool is updated based at least in part on said variables.

18. The method of claim 16, wherein the analysis provided by said offer section tool is updated based at least in part on information received from the client.
